(19) United States
(12) Patent Application Publication
(10) Pub. No.: US 2010/0320053 A1
(43) Pub. Date: Dec. 23, 2010

(54) Driving device for an adjusting system of a motor vehicle

(76) Inventors: Christof Goeke, Hallstadt (DE); Benjamin Nelson, Dettelbach (DE); Uwe Henning, Wurzburg (DE); Uwe Sommer, Effelder (DE)

Correspondence Address: CHRISTIE, PARKER & HALE, LLP, PO BOX 7068, PASADENA, CA, 91109-7068, US

(21) Appl. No.: 12/817,967

(22) Filed: Jun. 17, 2010

(30) Foreign Application Priority Data
Jun. 19, 2009 (DE) 10 2009 030 148.8
Jun. 30, 2009 (DE) 10 2009 031 555.1

(51) Int. Cl. F16D 63/00

(52) U.S. Cl. 192/215

(57) ABSTRACT

A driving device for an adjusting system of a motor vehicle includes a transmission with a drive element rotatably mounted about an axis of rotation for introducing a torque, a driven element rotatably mounted about the axis of rotation for delivering a torque, and a wrap spring brake device for transmitting a drive-side torque introduced by the drive element to the driven element and for blocking a driven-side torque applied on the driven element. It is provided that the drive element and the driven element each are mounted on a stationary portion of the transmission. In this way a driving device is created, whose drive element and driven element can have low bearing tolerances and which in addition is optimized in terms of friction to provide a smooth operation.

### CROSS-REFERENCE TO A RELATED APPLICATION

This application is a National US patent application, which claims priority of German Patent Application Number 10 2009 030 148.8, filed on Jun. 19, 2009, and of German Patent Application Number 10 2009 031 555.1, filed on Jun. 30, 2009.

### BACKGROUND

This invention relates to a driving device for an adjusting system of a motor vehicle according to the generic part of claim 1.

Such driving device includes a transmission which comprises a drive element rotatably mounted about an axis of rotation for introducing a torque and a driven element rotatably mounted about the same axis of rotation for delivering a torque to an adjustable part to be adjusted. The drive element and/or the driven element are at least partly enclosed by a transmission housing. To on the one hand transmit a drive-side torque introduced by the drive element to the driven element and on the other hand block a torque applied to the driven element on the driven side, a wrap spring brake device is provided, which couples the drive element with the driven element such that a drive-side torque is transmitted, but a driven-side torque is blocked.

The driving device for example can be part of a window regulator means of a vehicle door, in which a drive element in the form of a worm gear is driven by a drive motor, in order to adjust a window pane connected with a driven element.

In a driving device known from DE 10 2006 036 521 A1, a drive element is formed as worm gear which is coupled with a driven element in the form of an output shaft via a wrap spring brake device. The worm gear is driven via a drive worm of a drive motor and for adjusting an adjustable part, for example a window pane in the frame of a window regulator means, it is put into a rotary movement which is transmitted to the output shaft for adjusting the adjustable part.

In the driving device known from DE 10 2006 036 521 A1, the output shaft is rotatably mounted on a bearing stub of a transmission housing and extends through the worm gear which is mounted on the output shaft. This results in an indirect bearing of the worm gear on the output shaft, which leads to the fact that the tolerances of the bearing of the output shaft on the transmission housing and of the bearing of the worm gear on the output shaft are added up, which can have an influence on the engagement of a drive worm with a toothing of the worm gear.

In conventional wrap spring brake devices the drive element and the driven element are moved relative to each other by a predetermined distance, in order to actuate the wrap spring brake device for releasing or for blocking the driving device. It is desirable that the relative movement between the drive element and the driven element can be effected as smoothly as possible, in particular when a drive worm driving the drive element is mounted with low friction.

### SUMMARY

It is an object of the present invention to create a driving device whose drive element and driven element have low bearing tolerances and which in addition is optimized in terms of friction to provide a smooth operation.

It is provided that the drive element and the driven element are each mounted on a stationary portion of the transmission housing, wherein the driven element is mounted on a bearing collar of the transmission housing via a bearing portion formed by an outer circumferential surface.

Turning away from the solution of DE 10 2006 036 521 A1, the drive element of the driving device of the present invention is not mounted on the driven element (or vice versa) and hence mounted indirectly, but both the drive element and the driven element are directly mounted on a stationary portion of the transmission housing. Thus, the bearings of the drive element and of the driven element are separated, so that bearing-related tolerances do not add up and thus are reduced in general. In particular, the bearing clearance of the drive element thus is reduced, so that the center distance between the drive element and a drive shaft driving the drive element only has low tolerances and an engagement of the drive shaft (for example formed as worm shaft) into a toothing of the drive element (for instance formed as worm gear) can be effected safely and reliably and with little clearance.

In general, lower tolerances are obtained in the center distances in particular between the drive element and a drive shaft driving the drive element.

The drive element and the driven element advantageously each are mounted on the stationary portion of the transmission via a radial bearing. The stationary portion thus fixes the drive element and the driven element in radial direction, wherein the radial bearing can be formed for example by a bearing stub on the stationary portion of the transmission or by a ball bearing or the like.

The bearing of the driven element in radial direction here is effected via the bearing collar of the transmission housing, which advantageously fully encloses the bearing portion of the driven element. A radial bearing of the driven element on the transmission housing is obtained via the substantially cylindrically formed bearing portion, whose outer cylindrical shell surface is radially supported on the surrounding bearing collar of the transmission housing.

For axially fixing the driven element relative to the drive element, the driven element additionally is axially mounted on the drive element, and to minimize friction and to provide a smooth relative movement between the drive element and the driven element the axial bearing can be formed as a point-shaped point bearing. In axial direction, the driven element thus supports on the drive element and is fixed in axial direction via the drive element, wherein it is not required that the driven element extends through the drive element. Hence, it is not required either to provide openings or bores in the drive element for the driven element to extend therethrough, so that the structural stability of the drive element is improved.

The driven element can be mounted on a housing cover detachable from the remaining transmission housing, whereas the drive element is arranged on a portion of the remaining transmission housing. In the mounted condition, the housing cover is firmly connected with the transmission housing, for example in a positive, non-positive or firmly bonded manner, wherein the housing cover can be formed detachable from the remaining transmission housing.

In this way, the housing cover and the driven element can form a premountable unit, which for example also comprises the wrap spring brake device and which for assembly of the driving device is mounted on the remaining transmission housing.

Due to the fact that the driven element is mounted on a housing cover separate from the remaining transmission housing, several advantages are obtained.

Firstly, this provides the possibility of using a comparatively short and compact output shaft as driven element, which even under high torque loads has little torsion and hence is torsionally stable. This provides for using an inexpensive material for the output shaft.

Secondly, a short and compact construction of the output shaft leads to the fact that in operation the output shaft only is exposed to comparatively small deflections. A simple bearing on the housing cover hence can be sufficient; an additional support on other housing portions is not required.

Thirdly, the use of a housing cover with driven element arranged thereon and wrap spring brake device arranged thereon provides for easy assembly, in which driven element and wrap spring brake device first are arranged on the housing, in order to subsequently mount the preassembled unit thus created on the remaining transmission housing. The separation of an output unit (consisting of housing cover, driven element and wrap spring brake device) from the remaining housing thus provides for a high degree of standardization in a production line. The output unit can be completed on a preceding assembly station and subsequently be provided as preassembled unit for the final assembly of the driving device.

Fourthly, the separation of the output unit from the remaining transmission also provides for a higher degree of standardization for manufacturing a transmission housing. The transmission housing (without housing cover) can be manufactured and designed with the required screw-on domes for a mechanical attachment for example to a door module of a vehicle door and with electronic interfaces which possibly must be adapted individually and for the specific application, for example as an injection-molded part by the one-component technology. The housing cover can be manufactured by the two-component injection molding technology (two-component technology) and be provided with additional inserts, for example a bearing for the driven element and components of the wrap spring brake device, and is usable in standardized form for different types of transmission.

In an advantageous aspect, the wrap spring brake device can be arranged on the side of the drive element facing the driven element. In this way, a construction is obtained in which the wrap spring brake device completely is arranged on the same side of the drive element as the driven element. This simplifies both the construction of the driving device and the assembly, since wrap spring brake device and driven element with the housing cover can be attached to the drive element arranged in the remaining transmission housing as preassembled unit.

The wrap spring brake device for example includes a transmission element for transmitting a drive-side torque from the drive element to the driven element and a wrap spring arranged in a brake pot for blocking a driven-side torque. The transmission element can be mounted on a guide pin on the drive element and for this purpose include an oblong hole, through which the guide pin on the drive element extends. The transmission element is connected with end portions of the wrap spring and in operation of the driving device acts on the wrap spring, in order to either detach the wrap spring from the brake pot for transmitting a drive-side torque or to bring the wrap spring into frictional engagement with the brake pot for blocking a driven-side torque.

For example, if a drive-side torque is to be transmitted from the drive element to the driven element, the drive element acts on the transmission element, so that the transmission element for example contracts the wrap spring and hence brings the same out of frictional engagement with the brake pot. Blocking of the driving device hence is eliminated, the drive element becomes operatively connected with the driven element, and a torque is transmitted to the driven element.

On the other hand, if a torque is applied to the driven element on the driven side, for example because a force acts on an adjustable part, for example a window pane, coupled with the driven element, the transmission element blocks the output device, in that it forces the wrap spring apart and brings it into frictional engagement with the brake pot. Rotating the driven element hence becomes impossible, so that the driving device is blocked and the adjustable part cannot be adjusted. In this way, an adjustment of the driving device as a result of a load acting on the adjustable part is prevented, in order to exclude an inadvertent adjustment of the adjustable part.

On the brake pot a metallic brake ring can be arranged to establish a frictional connection of the wrap spring with the brake pot, wherein brake ring and wrap spring are adjusted to each other in their materials, in order to establish a frictional engagement in a reliable manner.

Advantageously, the brake pot is integrally molded to the housing cover of the transmission housing, for example by the two-component technology, and accommodates the brake ring and the wrap spring, so that the wrap spring brake device and the driven element together with the housing cover can be mounted to the remaining transmission housing as a preassembled unit.

In an advantageous aspect, the driving device is designed such that its assembly can be effected in a single mounting direction. This means that for assembly the drive element and the preassembled unit consisting of housing cover, driven element and wrap spring brake device must be attached to the transmission housing in the same mounting direction. First of all, the drive element for example is inserted in the transmission housing in the form of a worm gear and subsequently the preassembled unit consisting of housing cover, driven element and wrap spring brake device is attached to the transmission housing and fixed at the same. In general, this provides for a considerable simplification of the assembly on a production line and for a further standardization of the assembly.

### BRIEF DESCRIPTION OF THE DRAWINGS

The idea underlying the invention will be explained in detail below with reference to the embodiments illustrated in the Figures, in which:

FIG. 1 shows a partial sectional view through a driving device with a drive element in the form of a worm gear and a driven element in the form of an output shaft;

FIG. 2 shows a further partial sectional view of a driving device with a drive element in the form of a worm gear and a driven element in the form of an output shaft;

FIGS. 3A, 3B show perspective detailed views of the worm gear and the output shaft of the driving device as shown in FIG. 2;

FIG. 4 shows another embodiment of a driving device with a worm gear and an output shaft;

FIG. 5 shows a further embodiment of a driving device with a worm gear and an output shaft;

FIGS. 6A, 6B show perspective detailed views of the worm gear and the output shaft of the driving device as shown in FIG. 5;

FIGS. 7A, 7B show sectional views through a further embodiment of a driving device with a worm gear and an output shaft;

FIG. 8 shows a top view of an embodiment of a driving device;

FIG. 9 shows an exploded view of the driving device as shown in FIG. 8, and

FIG. 10 shows a sectional view of the driving device along line A-A in FIG. 8.

### DETAILED DESCRIPTION

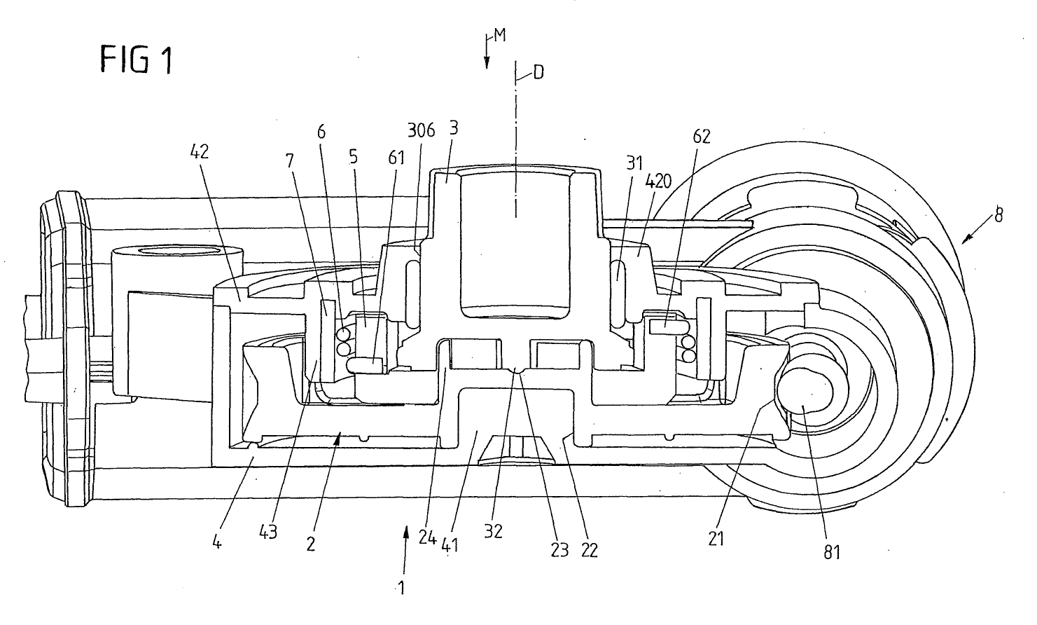

FIG. 1 shows a driving device 1 which can functionally be divided into a drive motor 8 and a transmission. The transmission is formed by a drive element 2 in the form of a worm gear, a driven element 3 in the form of an output shaft and a wrap spring brake device, substantially consisting of a transmission element 5, a wrap spring 6, a brake ring 7 and a brake pot 43.

The drive element 2 and the driven element 3 each are rotatable about an axis of rotation D and are enclosed by a transmission housing 4. The drive element 2 is rotatably arranged on a bearing stub 41 of the transmission housing 4, whereas via a cylindrical bearing portion 306 via a radial bearing 31, for example a ball bearing, the driven element 3 is mounted on a bearing collar 420 of a housing cover 42 of the transmission housing 4, which fully encloses the bearing portion 306 and which in the mounted condition of the driving device 1 is firmly connected with the remaining transmission housing 4.

The bearing portion 306 is formed by an outer cylindrical shell surface, which is supported on the bearing collar 420 of the housing cover 42 via the radial bearing 31.

The operation of the driving device 1 substantially is as described in DE 10 2006 036 521 A1. In operation of the driving device 1, a drive worm 81 of the drive motor 8, which is in engagement with an external toothing 21 of the drive element 2 via a worm toothing, drives the drive element 2 and puts the same into a rotary movement about the axis of rotation D. Analogous to the construction of the driving device in DE 10 2006 036 521 A1, the drive element 2 includes an axially extending actuating element (not shown in FIG. 1), which is formed to make contact with the transmission element 5 of the wrap spring brake device in the case of a rotary movement of the drive element 2. In this way, the transmission element 5 arranged on a pin 24 of the drive element 2 via an oblong hole is actuated such that the wrap spring 6, which is connected with the transmission element 5 via end portions 61, 62, is contracted, thereby reduced in its outside diameter and gets out of frictional engagement with the brake ring 7. The driving device 1 thus is unlocked; the wrap spring 6 is out of frictional engagement with the brake ring 7. Via the transmission element 5, the drive element 2 with its drive-side actuating element arranged thereon then becomes operatively connected with an actuating element of the driven element 3—again analogous to the description in DE 10 2006 036 521 A1—and puts the driven element 3 into a rotary movement.

On the other hand, if a driven-side torque is applied to the driven element 3, the driven element 3 with its driven-side actuating element arranged thereon becomes operatively connected with the transmission element 5 and actuates the same such that the wrap spring 6 is expanded and gets into frictional engagement with the brake ring 7. The driving device 1 hence is blocked and the torque applied on the driven side is not transmitted to the drive element 2.

In this way, the wrap spring brake device provides for transmitting torques applied on the driven side to the output in a low-friction manner, but torques applied on the driven side are blocked such that an adjustment of an adjustable part connected with the driven element 3, for example a window regulator mechanism connected with the driven element 3, is not possible.

Turning away from the driving device of DE 10 2006 036 521 A1, the drive element 2 of the present driving device 1 as shown in FIG. 1 is directly mounted on the transmission housing 4. For this purpose, the drive element 2 includes a blind hole 22 on its bottom surface shown in FIG. 1, in which an axially extending bearing stub 41 arranged on the transmission housing 4 engages to form a radial bearing. The drive element 2 hence is directly mounted on the transmission housing 4, whereby bearing tolerances due to the manufacturing technology used, which in particular can have an influence on the center distance between the drive element 2 and the drive worm 81, are small and in particular do not add up as in an indirect bearing.

Further turning away from the driving device according to DE 10 2006 036 521 A1, the driven element 3 of the present driving device 1 is mounted on the surrounding bearing collar 420 of the housing cover 42 of the transmission housing 4 via the bearing portion 306 and the radial bearing 31. The radial bearing 31 provides a radial support of the driven element 3 and can for example constitute a smoothly running ball bearing. In addition, the driven element 3 is axially mounted on a bearing point 23 of the drive element 2 via a point bearing 32 and hence supported with respect to the drive element 2. The point bearing 32 here can provide a purely point-shaped support, which can be of the low-friction type and hence ensures a smooth relative movement of the drive element 2 relative to the driven element 3.

The driven element 3 does not extend through the drive element 2, but is axially supported merely with respect to the drive element 2 at one point.

In the present driving device 1, further turning away from the driving device of DE 10 2006 036 521 A1, an output unit consisting of the driven element 3, the housing cover 42 and the wrap spring brake device is completely arranged on the side of the drive element 2 facing the driven element 3. In this way, the output unit forms a unit which can be preassembled and in the preassembled condition can be provided for the final assembly of the driving device 1 and be attached to the remaining transmission housing 4. For preassembly, the driven element 3 with the radial bearing 31 first is attached to the housing cover 42, and the components of the wrap spring brake device, namely the brake ring 7, the wrap spring 6 and the transmission element 5, are inserted into the brake pot 43. This preassembled unit then can be attached to the drive element 2 inserted in the transmission housing 4, in order to complete the driving device 1.

An advantage of this arrangement is its simple construction and the possibility of an easy assembly. In particular, the final assembly of the driving device 1 can completely be effected in a mounting direction M, in that first of all the drive element 2 is attached to the bearing stub 41 of the transmission housing 4 in mounting direction M and subsequently the preassembled unit consisting of driven element 3, wrap spring brake device and housing cover 42 is attached to the drive element 2 in mounting direction M. To complete the assembly, the housing cover 42 then is connected with the transmission housing 4, wherein the connection can be effected for example in a positive, non-positive or also firmly bonded manner by welding or the like.

The construction of the driving device 1 provides for a high degree of standardization. Firstly, a largely standardized assembly becomes possible, in that an output unit is preassembled as usual and for final assembly attached to the remaining driving device 1. Secondly, units can also be standardized for different embodiments and applications, in that one standardized, identically constructed output unit is used for different driving devices and is connected with a transmission housing 4 individualized in terms of its screw-on domes and electronic interfaces. Merely the transmission housing 4 hence must individually be adapted to the circumstances and applications. The output unit always can be formed identically.

Further advantages result from the short construction of the driven element 3 in the form of the output shaft. Due to the short and compact formation of the driven element 3, the same is torsionally stable and at the same time can only slightly deflect in operation of the driving device 1, so that a support in radial direction via the bearing portion 306 and the radial bearing 31 on the bearing collar 420 of the housing cover 42 and in axial direction via the point bearing 32 is sufficient.

Furthermore, the drive element 2 has a high structural strength, since the openings and recesses are not required for the driven element 3 to extend therethrough.

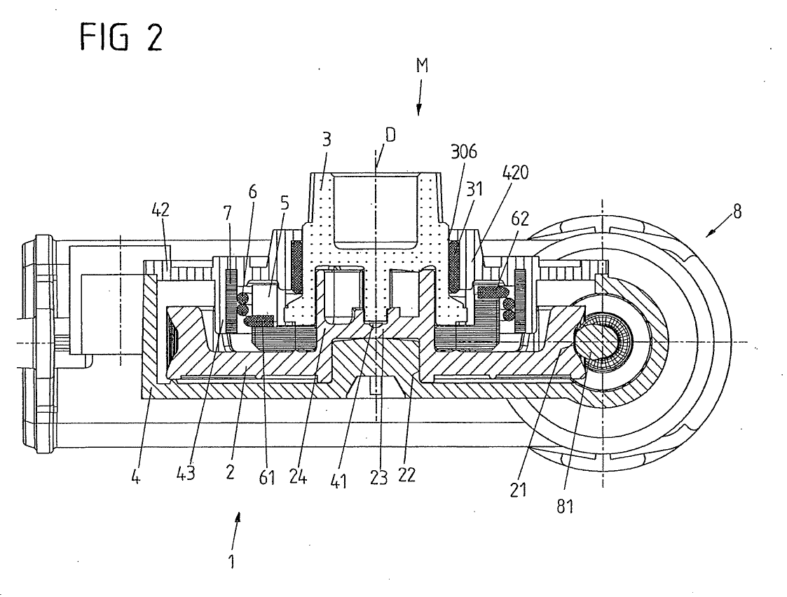

A merely slightly modified construction of a driving device 1 is shown in FIG. 2. In terms of its function, the driving device 1 as shown in FIG. 2 is identical to the above-described driving device 1 as shown in FIG. 1. Merely the formation of the pin 24 of the worm gear 2 for arrangement of the transmission element 5 and the driven element 3 is modified.

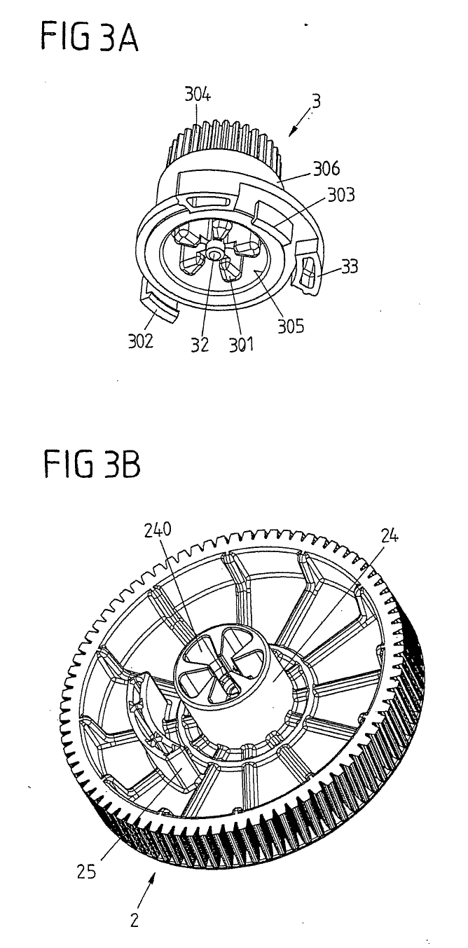

FIGS. 3A and 3B show perspective detailed views of the driven element 3 (FIG. 3A) and of the drive element 2 (FIG. 3B) of the embodiment as shown in FIG. 2.

The driven element 3 and the drive element 2 each include an actuating element 33, 25 protruding towards the other component in axial direction, which are formed to cooperate with the transmission element 5 for actuating the wrap spring brake device.

When a torque is applied to the drive element 2, the drive element 2 is rotated about the axis of rotation D, so that the actuating element 25 comes in abutment with the lever-like transmission element 5 and by actuation of the transmission element 5 contracts the wrap spring 6 and brings it out of frictional engagement with the brake ring 7. Via the transmission element 5, the actuating element 25 then becomes operatively connected with the actuating element 33 of the driven element 3 and transmits the torque to the driven element 3.

However, when a torque is applied to the driven element 3 on the driven side, the actuating element 33 actuates the transmission element 5 to expand the wrap spring 6, so that the wrap spring 6 establishes a frictional engagement with the brake ring 7. The driving device 1 is blocked, and the driven-side torque is blocked.

The operation of the transmission element 5 is as described in DE 10 2006 036 521 A1.

The driven element 3 includes a toothing 304, via which the driven element 3 can cooperate with a driven-side adjusting means, for example a window regulator mechanism.

On the driven element 3, two latching elements 302, 303 are provided, which hold the transmission element 5 in engagement with the driven element 3.

Via the point bearing 32, the driven element 3 axially rests against the drive element 2. Via projections 301 in an inner bore 305, the driven element 3 furthermore engages in recesses 240 on the pin 24 of the drive element 2, wherein the recesses 240 permit a relative movement of the drive element 2 relative to the driven element 3 for actuation of the transmission element 5. The projections 301 provide an additional radial support of the driven element 3 relative to the drive element 2.

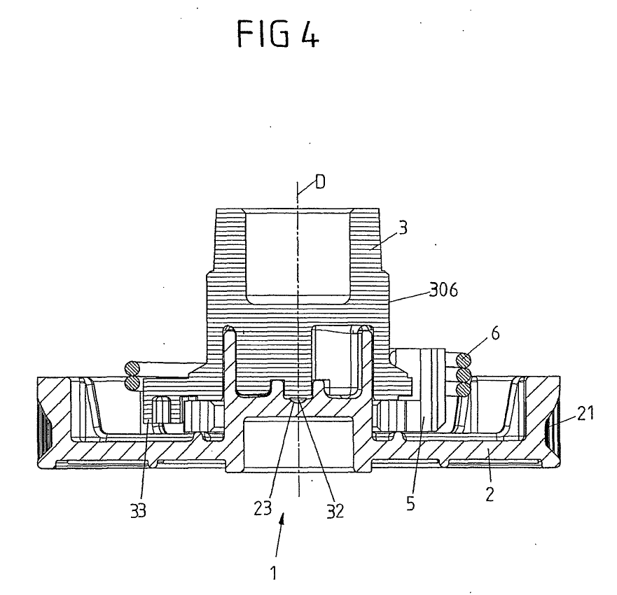

FIG. 4 shows a configuration of a driving device 1 (shown without transmission housing), in which an axial support of the driven element 3 is provided via a point bearing 32 on the drive element 2, as described above. The embodiment of FIG. 4 differs from the preceding embodiments by the configuration of the transmission element 5 and of the actuating elements cooperating therewith. However, the operation of the driving device 1 otherwise is as described above.

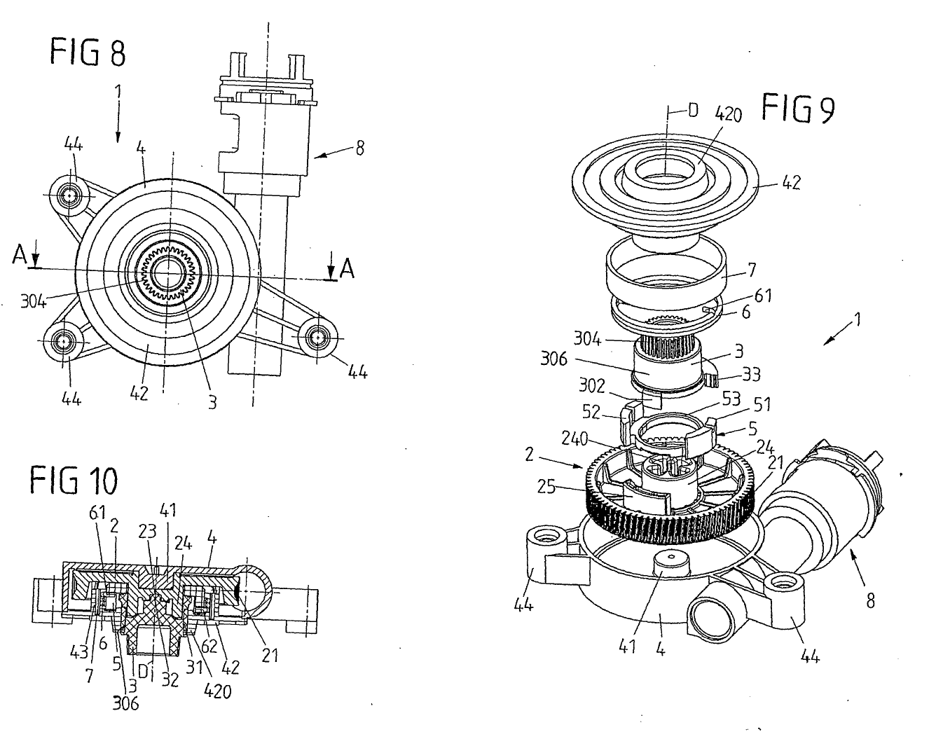

FIGS. 8 to 10 show different views of a further embodiment of a driving device 1, which in its operation is largely identical with the embodiments described above. Components of identical function are provided with the reference numerals also used above, as far as expedient.

FIG. 8 shows a top view of the driving device 1 enclosed in a transmission housing 4, FIG. 9 shows an exploded view, and FIG. 10 shows a sectional view along line A-A of FIG. 8.

In the driving device 1 as shown in FIGS. 8 to 10, a drive element 2 in the form of a worm gear is rotatably mounted in a transmission housing 4 via a pin 41, as also explained above. On a pin 24 of the drive element 2 a transmission element 5 with an oblong hole 53 is seated, which is part of a wrap spring brake device and in operation cooperates with a wrap spring 6, which is connected with the transmission element 5 via end portions 61, 62 and is arranged in a brake ring 7 mounted inside a brake pot 43.

The wrap spring brake device, comprising the transmission element 5, the wrap spring 6 and the brake ring 7, is arranged on a housing cover 42, wherein a driven element 3 also is arranged on the housing cover 42 via a bearing collar 420, a radial bearing 31 and a bearing portion 306. As described above, the driven element 3 arranged on the housing cover 42 and the wrap spring brake device can form a preassembled unit, which in the preassembled condition can be attached to the transmission housing 4.

Via a point bearing 32, the driven element 3 is axially supported on the drive element 2 and for this purpose engages in recesses 240 in the pin 24 of the drive element 2, which permit, however, a relative movement about the axis of rotation D of the drive element 2 relative to the driven element 3.

On each of the drive element 2 and the driven element 3 actuating elements 25, 33 are arranged, which in operation of the driving device 1 cooperate with the transmission element 5 on the one hand for transmitting a drive-side torque to the driven element 3 and on the other hand for actuating the wrap spring brake device for blocking a driven-side torque.

The transmission element 5 includes actuating elements 51, 52 which upon application of a drive-side torque become operatively connected with the actuating element 25 of the drive element 2 and with the actuating element 33 of the driven element 3, in order to transmit a torque from the drive element 2 to the driven element 3.

When the drive element 2 for example is rotated in clockwise direction (with reference to the viewing direction of the top view of FIG. 8) about the axis of rotation D, the actuating element 25 of the drive element 2 gets in abutment with the actuating element 52 of the transmission element 5 and shifts the transmission element 5 bearing on the pin 24 of the drive element 2 via the oblong hole 53 (as described in DE 10 2006 036 521 A1), so that the wrap spring 6 contracts and gets out of frictional engagement with the brake ring 7. With a further rotation of the drive element 2, the actuating element 52 gets in abutment with the actuating element 33 of the driven element 3, so that the driven element 3 is also put into a rotary movement and a torque is transmitted to the driven element 3.

With a reverse rotary movement of the drive element 2 in anticlockwise direction, the actuating element 25 first gets in abutment with the actuating element 51 of the transmission element 5 and actuates the transmission element 5 such that the wrap spring 6 gets out of frictional engagement with the brake ring 7.

On the other hand, when a torque is applied to the driven element 3 on the driven side, the actuating element 33 of the driven element 3 gets in abutment either with the actuating element 51 or the actuating element 52 of the transmission element 5 in dependence of the direction of the torque and actuates the transmission element 5 such that the wrap spring 6 expands and gets into frictional engagement with the brake ring 7. The driving device 1 thereby is blocked; the driven-side torque is not transmitted to the drive element 2, but introduced into the brake pot 43 via the brake ring 7.

FIG. 9 also shows latching elements 302 on the driven element 3, by means of which the transmission element 5 can be arranged on the driven element 3 for the purpose of preassembly.

FIGS. 8 and 10 also show mounting points 44 in the form of screw-on domes on the transmission housing 4, which serve for mounting the driving device 1 to a vehicle door, for example to an assembly carrier of a door module.

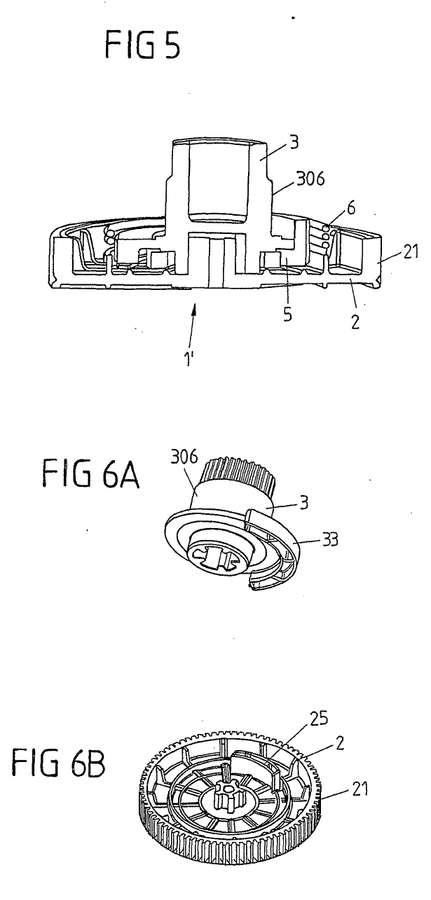

Another configuration of a driving device 1′ is shown in FIG. 5 in a sectional view and in FIGS. 6A and 6B in perspective views. As far as expedient, components of identical function are provided with the same reference numerals as above.

In contrast to the embodiment as shown in FIG. 1, the driven element 3 of the driving device 1′ is not supported in a point-shaped manner with respect to the drive element 2, but bears on the drive element 2 via a ring-shaped support. In turn, the output unit consisting of driven element 3, wrap spring brake device (with the transmission element 5 and the wrap spring 6) and housing cover (not shown in FIGS. 5 and 6A, 6B) is completely arranged on the side of the drive element 2 facing the driven element 3.

FIGS. 6A and 6B show perspective views of the driven element 3 and of the drive element 2 in the form of an output shaft or a worm gear with actuating elements 25, 33 arranged thereon for actuating the transmission element 5 of the wrap spring brake device.

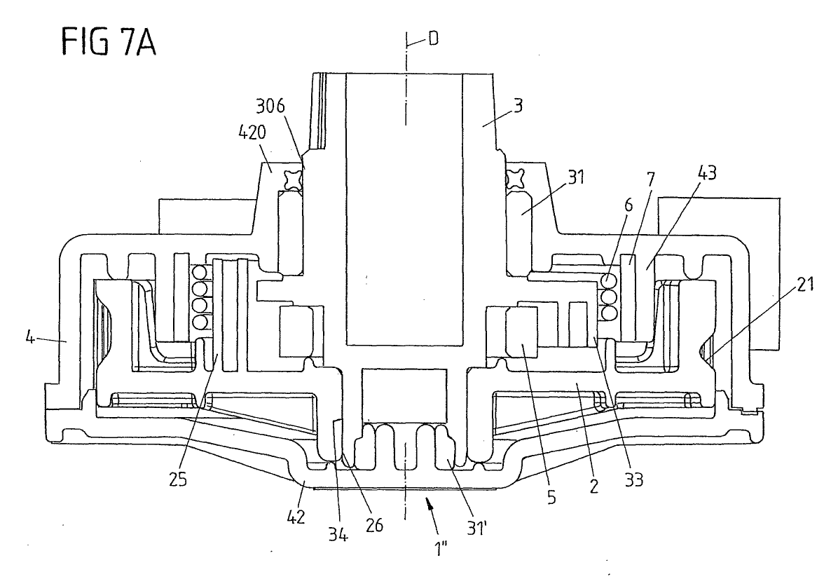

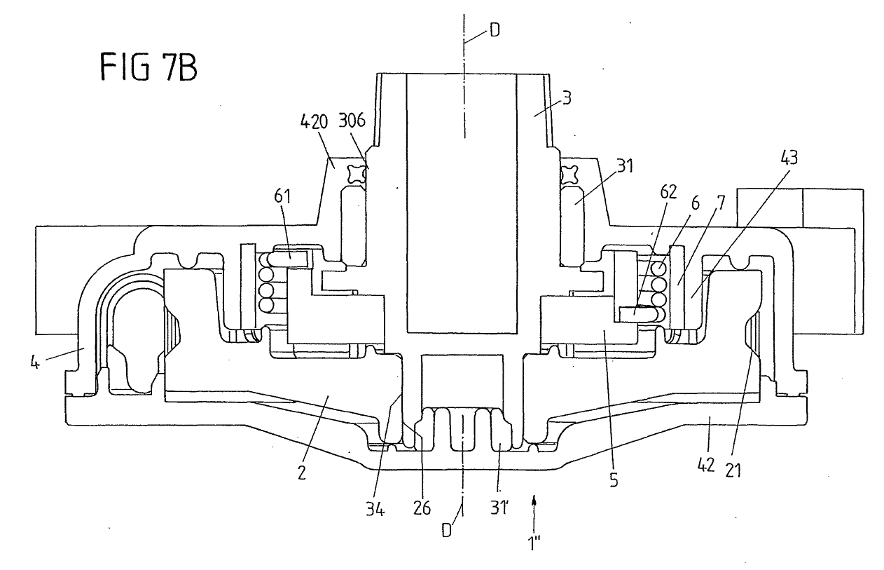

Another embodiment of a driving device 1″ is shown in FIGS. 7A, 7B in different sectional views. The sectional view of FIG. 7A is offset by 90° about the axis of rotation D as compared to the sectional view of FIG. 7B. As far as expedient, components of identical function again are provided with the same reference numerals as above.

In contrast to the driving device 1 as shown in FIG. 1, the driven element 3 in the embodiment as shown in FIGS. 7A, 7B extends through the drive element 2 in an opening provided for this purpose. The drive element 2 in the form of a worm gear is not radially supported on the transmission housing 4, but on a bearing portion 34 of the driven element 3 and hence includes an indirect bearing. The driven element 3 on the one hand is supported on the transmission housing 4 via a radial bearing 31 and on the other hand on a housing cover 42 via a radial bearing 31′. The radial bearings 31, 31′ each can be formed as ball bearings.

A wrap spring brake device (with a transmission element 5, a wrap spring 6, a brake ring 7 and a brake pot 43), which can be actuated via actuating elements 25, 33 on the drive element 2 and on the driven element 3, respectively, is arranged on the side of the drive element 2 facing the driven element 3.

The idea underlying the invention is not limited to the embodiments described above, but generally can also be realized in completely different embodiments. For example, the driving device of the type described can be used for window regulator means of a motor vehicle, but generally can also be used for adjusting another adjustable part in a motor vehicle. Via the driven element, a torque then is delivered on the driven side, which produces the adjusting force required for adjusting the adjustable part.

1. A driving device for an adjusting system of a motor vehicle, including a transmission comprising:
a drive element rotatably mounted about an axis of rotation for introducing a torque;
a driven element having a bearing portion formed by an outer circumferential surface, the drive element being rotatably mounted about the axis of rotation for delivering a torque;
a transmission housing having a stationary portion and a bearing collar, the transmission housing at least partly enclosing at least one of the drive element and the driven element; and
a wrap spring brake device to transmit a drive-side torque introduced by the drive element to the driven element and to block a driven-side torque applied on the driven element, wherein the drive element and the driven element each are mounted on the stationary portion of the transmission housing, wherein the driven element, via the bearing portion formed by the outer circumferential surface, is mounted on the bearing collar of the transmission housing.

2. The driving device according to claim 1, wherein the drive element and the driven element each are supported on the stationary portion via a radial bearing.

3. The driving device according to claim 1, wherein the bearing collar of the transmission housing fully encloses the bearing portion of the driven element.

4. The driving device according to claim 1, wherein the driven element is axially supported on the drive element via an axial bearing.

5. The driving device according to claim 4, wherein the axial bearing is of the point-shaped type.

6. The driving device according to claim 1, wherein the driven element is supported on a housing cover to be mounted on the transmission housing.

7. The driving device according to claim 1, wherein the wrap spring brake device is arranged on a side of the drive element facing the driven element.

8. The driving device according to claim 1, wherein the wrap spring brake device includes a transmission element for transmitting a drive-side torque from the drive element to the driven element and for blocking a driven-side torque, and a wrap spring arranged in a brake pot, which wrap spring is connected with the transmission element for blocking the driven-side torque.

9. The driving device according to claim 8, wherein the transmission element is mounted on a guide pin on the drive element.

10. The driving device according to claim 8, wherein the transmission element defines an oblong hole, through which extends a guide pin on the drive element.

11. The driving device according to claim 8, wherein the transmission element is connected with end portions of the wrap spring in order to release the wrap spring from the brake pot for transmitting a drive-side torque or to bring the wrap spring into frictional engagement with the brake pot for blocking a driven-side torque.

12. The driving device according to 8, wherein a brake ring is arranged on the brake pot to establish a frictional connection of the wrap spring with the brake pot.

13. The driving device according to claim 12, wherein the brake pot is arranged on a housing cover of the transmission housing.

14. The driving device according to claim 1, wherein the driving device is configured to be mounted in a single mounting direction.
